(19) United States
(12) Patent Application Publication
(10) Pub. No.: US 2008/0165648 A1
(43) Pub. Date: Jul. 10, 2008

(54) METHOD OF IMPROVING DEFECT COUNTERMEASURE OF APPARATUS FOR REPRODUCING OPTICAL INFORMATION STORAGE MEDIUM

(75) Inventors: An-sik JEONG, Hwaseong-si (KR); Jong-hyun Shin, Suwon-si (KR); Tatsuhiro Otsuka, Suwon-si (KR); Young-Jae Park, Younglin-si (KR); Sung-Hyun Kim, Youngin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/855,270

(22) Filed: Sep. 14, 2007

(30) Foreign Application Priority Data
Jan. 9, 2007 (KR) 2007-2677

(51) Int. Cl. G11B 5/09

(52) U.S. Cl. 369/53.17

(57) ABSTRACT

A method of improving a defect countermeasure of an apparatus for reproducing an optical information storage medium. The method includes generating a defect detection signal corresponding to a defect duration from an RF signal input from an optical pickup, outputting a servo hold signal by performing an AND operation of the defect detection signal and a predetermined pulse width modulation signal, and if reproduction fails in a servo hold on state, switching the servo hold on state to a servo hold off state, outputting the servo hold signal again by reflecting a time delay on a pulse width of the servo hold signal when entering into the defect duration again, and adding track and focus offsets to a held servo value of the time delayed servo hold on duration. Accordingly, a countermeasure of a case where normal data reading fails due to a defect can be improved.

### CROSS-REFERENCE TO RELATED APPLICATION

This application claims all benefits accruing under 35 U.S.C. §119 from Korean Patent Application No. 2007-2677, filed in the Korean Intellectual Property Office on Jan. 9, 2007, the disclosure of which is incorporated herein by reference.

### BACKGROUND OF THE INVENTION

1. Field of the Invention

Aspects of the present invention relate to a method of improving a defect countermeasure of an optical information storage medium reproducing apparatus and, more particularly, to a method of improving a defect countermeasure of an optical information storage medium reproducing apparatus, whereby the defect countermeasure is improved by adding an offset to a servo hold signal.

2. Related Art

Optical information storage media include optical discs such as Compact Discs (CDs), Digital Versatile Discs (DVDs), and the like. Due to the recording capacity and fast access times of optical information storage media, they are widely used to store multimedia data, such as audio, video, and digital data. In particular, in the case of Blue-ray Disc™ (BD), since bulk data of more than 25 GB can be stored on one side of a BD, the usage and worth of the BD as a multimedia storage medium is increasingly prevalent.

Generally, optical disc reproduction apparatuses reproduce a signal based on whether the intensity of a reflected signal detected by a contactless optical head is high or low. Since optical disc reproduction apparatuses use a contactless optical head, quality degradation of optical discs can be prevented as compared to recording media contacted by a contact head, such as a tape. Optical disc reproduction apparatuses are relatively resistant to dust or scratches on an optical disc.

Various physical defects occur easily, either on a reproduction side or the opposite side of optical disc storage media, during manufacture or use of optical discs. Defects that can occur in a disc manufacturing process include, for example, interruptions indicating that a portion of a data recording side of a disc is missing and bubble defects indicating that bubbles adhered to a disc surface during an optical disc coating process. Defects that can occur during usage when an optical disc is not loaded in a cartridge include, for example, scratches, fingerprints, water spots, black-dots, and pin-holes through which a laser beam may be transmitted.

These defects significantly affect optical disc reproduction apparatuses by disabling or obstructing signal reproduction. Defects can cause distortion or loss of a reproduced signal and malfunction of a servo signal requisite to the signal reproduction. Thus, optical disc reproduction apparatuses hold a servo signal to a previous value while a specific defect is detected and generates the servo signal normally when the defect duration is over.

FIGS. 1A and 1B show waveforms in a defect duration; that is, if an optical disc has a defect, a signal fluctuates, and a servo error signal is held to a previous value while the fluctuated portion is detected. Referring to FIG. 1A, while a normal servo error signal is detected, a servo on state in which a track servo or a focus servo is actuated is maintained. However, if a defect is detected, since an abnormal waveform is generated while the defect is detected in a servo hold off state, servo control may be unstable. Therefore, a servo error signal, which is held at a previous value, is output in a servo hold on state while the defect is detected, as shown in FIG. 1B. When the defect is no longer detected, the servo on state in which the normal servo error signal is generated is maintained again.

Depending on the size, pattern, or characteristic of a defect, when the track servo or the focus servo is actuated in an original state, i.e., a normal state, after it was held to a previous value while a defect was detected, servo control may be unstable and tracking may be incorrect, resulting a failure to reproduce data accurately. In particular, in a case of a BD, which has a narrower track width than other optical discs, according to the size or pattern of a defect, a range influenced in the BD by the defect may reach thousands of tracks. In this case, the duration in which the defect is detected exceeds a predetermined time, or a Radio Frequency (RF) signal is irregularly generated, resulting in an increase of the probability of a data reproduction failure.

### SUMMARY OF THE INVENTION

Aspects of the present invention provide a method of improving a defect countermeasure of an optical information storage medium reproducing apparatus, whereby the defect countermeasure is improved by increasing a reproduction success rate even in a state where the eccentricity is large or a Radio Frequency (RF) signal is unstable.

Additional aspects and/or advantages of the invention will be set forth in part in the description which follows and, in part, will be obvious from the description, or may be learned by practice of the invention.

According to an aspect of the present invention, a method of improving a defect countermeasure of an optical information storage medium reproducing apparatus is provided. The method comprises generating a defect detection signal corresponding to a duration of a state in which an optical information storage medium reproducing apparatus is detecting a defect in an optical information storage medium based on an RF signal input from an optical pickup; outputting a servo hold signal by performing an AND operation on the defect detection signal and a predetermined pulse width modulation signal to change operation to a servo hold “on” state in which a servo drive signal is held at a previous value of the servo drive signal; reproducing data stored on the optical information storage medium using the servo drive signal; and if reproduction fails in a servo hold on state, switching from the servo hold “on” state to a servo hold “off” state in which the servo signal is not held at a previous value of the servo drive signal, outputting the servo hold signal again by adding a time delay on a pulse width of the servo hold signal when entering into the defect duration again, and adding track and focus offsets to the previous value of the servo drive signal.

According to another aspect of the present invention, the method further comprises readjusting the track offset and/or the focus offset when entering into the defect duration again if the reproduction of the data fails while operating in the servo hold on state after adding the time delay and the track and focus offsets to the servo hold signal.

According to another aspect of the present invention, the method further comprises readjusting the time delay when entering into the defect duration again if the reproduction of the data fails while operating in the servo hold on state after adding the time delay and the track and focus offsets to the servo hold signal.

According to another aspect of the present invention, the method further comprises restoring the track and focus offsets to a value of a normal state if the reproduction of the data succeeds while operating in the servo hold on state after adding the time delay and the track and focus offsets to the servo hold signal.

According to another aspect of the present invention, an optical information storage medium reproducing apparatus is provided. The apparatus comprises an optical pickup to generate an electrical RF signal by optically picking up information recorded on an optical information storage medium; an optical amplifier to generate a defect detection signal corresponding to a duration of a state in which the apparatus is detecting a defect in the optical information storage medium based on the RF signal input from the optical pickup; a defect processing unit to output a servo hold signal by performing an AND operation on the defect detection signal and a predetermined pulse width modulation signal; a servo signal processing unit to output a servo drive signal using the servo hold signal; and a controller to control the optical pickup based on the servo drive signal and to control the optical pickup to reproduce data stored on the optical information storage medium; wherein, if reproduction of data on the optical information storage medium fails while the apparatus is operating in a servo hold on state in which the servo drive signal is held at a previous value, the servo hold on state is switched to a servo hold off state in which the servo drive signal is not held at the previous value, and when entering into the defect duration again, the defect processing unit outputs the servo hold signal again by adding a time delay on a pulse width to the servo hold signal, and the servo signal processing unit adds track and focus offsets to the previous value of the servo drive signal.

According to another aspect of the present invention, the defect processing unit may comprise: a mono-multi-vibrator to output the pulse width modulation signal from when the defect detection signal changes; and a logic operation unit to output the servo hold signal by performing the AND operation on the defect detection signal and the pulse width modulation signal.

According to another aspect of the present invention, a computer readable recording medium is provided. The computer readable recording medium stores a computer readable program to execute a method of improving a defect countermeasure of an optical information storage medium reproducing apparatus. The method comprises generating a defect detection signal corresponding to a duration of a state in which the optical information storage medium reproducing apparatus is detecting a defect in an optical information storage medium from an RF signal input from an optical pickup; outputting a servo hold signal by performing an AND operation of the defect detection signal and a predetermined pulse width modulation signal; reproducing data based on a servo drive signal; and if reproduction fails while the optical information storage medium reproducing apparatus is operating in a servo hold on state in which the servo drive signal is held at a previous value, switching the servo hold on state to a servo hold off state in which the servo drive signal is not held to the previous value, outputting the servo hold signal again by adding a time delay to a pulse width of the servo hold signal when entering into the defect duration again, adding track and focus offsets to the previous value of the servo drive signal.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIGS. 1A and 1B show waveforms in a defect duration;

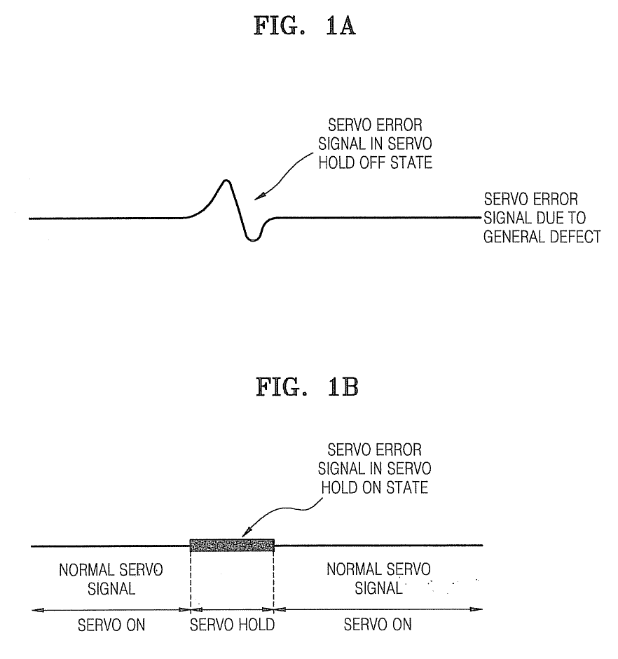

FIG. 2 is a block diagram of an apparatus for reproducing an optical information storage medium according to an example embodiment of the present invention;

FIG. 3 is a block diagram of a defect processing unit according to an example embodiment of the present invention;

FIGS. 4A-4D and 5 are diagrams for describing a method of processing a defect detection signal according to an example embodiment of the present invention; and

FIG. 6 is a flowchart of a method of processing a defect detection signal by adjusting an offset of a pulse width of a servo hold signal according to an example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

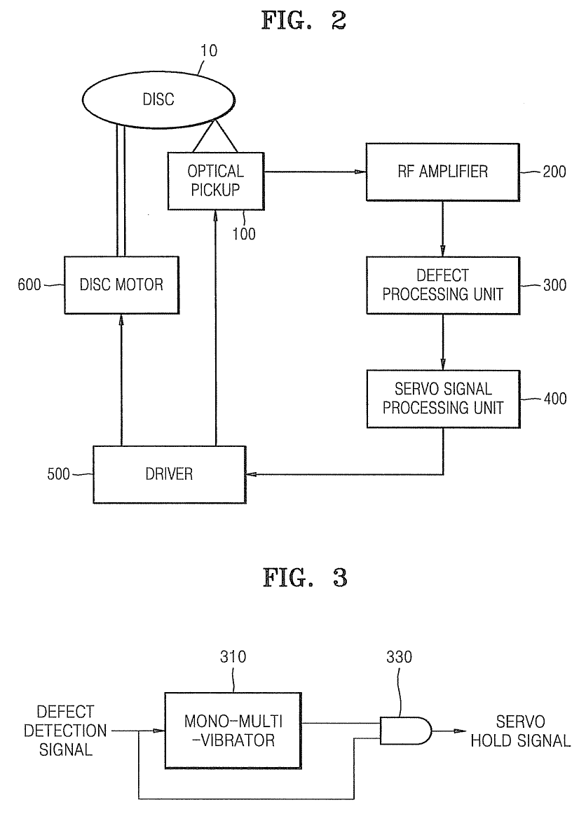

FIG. 2 is a block diagram of an optical disc reproduction apparatus according to an example embodiment of the present invention. The optical disc reproduction apparatus includes an optical pickup 100, a Radio Frequency (RF) amplifier 200, a servo signal processing unit 300, a servo signal processing unit 400, a driver 500, and a disc motor 600.

The optical pickup 100 is driven by a tracking actuator (not shown) to control a tracking servo and a focusing actuator (not shown) to control a focus servo. The optical pickup 100 generates an electrical RF signal by optically picking up information recorded on an optical disc 10. The RF amplifier 200 amplifies the RF signal input from the optical pickup 100. The RF amplifier 200 includes a focus error detection circuit (not shown) and a tracking error detection circuit (not shown). The RF amplifier 200 generates a servo error signal, such as a focus error (FE) signal and a tracking error (TE) signal, from the amplified RF signal.

The defect processing unit 300 outputs a defect processing signal, i.e., FE and TE signals in which a servo hold signal is included, by modifying a predetermined pulse width of the servo error signal in response to a size of a defect in the optical disc 10. The servo signal processing unit 400 includes a focus servo control loop (not shown) and a tracking servo control loop (not shown) and outputs a focus drive (FOD) signal and a tracking drive (TRD) signal by compensating a gain and phase for the defect processing signal generated by the defect processing unit 300.

The driver 500 uses the FOD signal and the TRD signal output from the servo signal processing unit 400 to drive the disc motor 600, the tracking actuator (not shown), and the focusing actuator (not shown). The disc motor 600 rotates the disc in a Constant Linear Velocity (CLV) or Constant Angular Velocity (CAV) method using a disc driving signal output from the driver 500.

A method of processing a defect on an optical disc using the defect processing unit 300 will now be described.

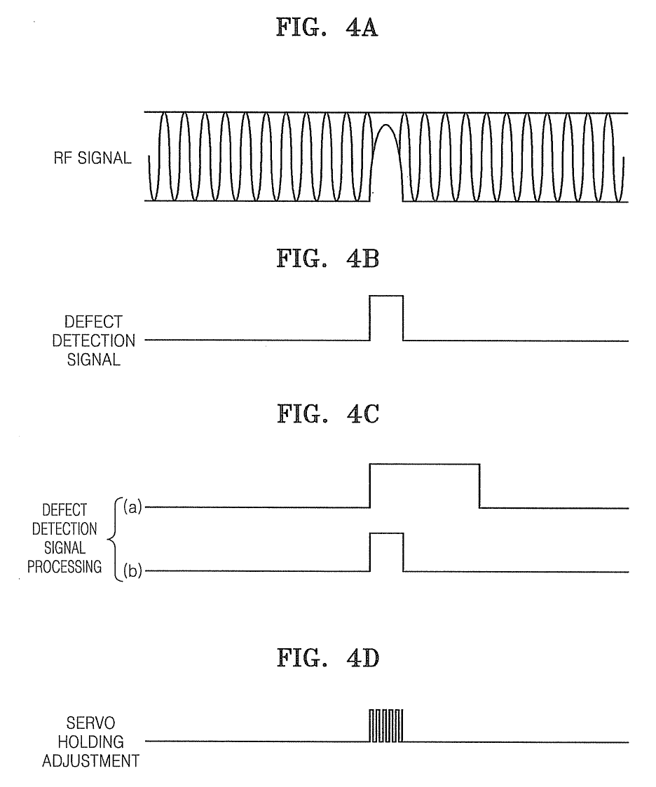

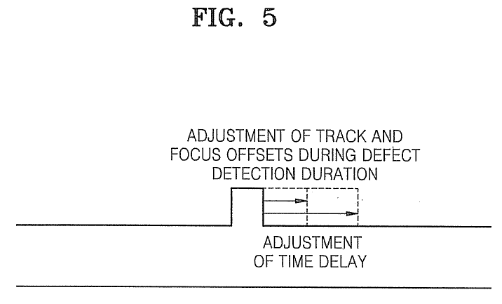

FIG. 3 is a block diagram of the defect processing unit 300 according to an example embodiment of the present invention. FIGS. 4A-4D and 5 are diagrams describing a method of processing a defect detection signal according to an example embodiment of the present invention. The defect processing unit 300 includes a mono-multi-vibrator 310 and an AND gate 330.

If the optical disc 10 has a defect, the RF signal amplified by the RF amplifier 200 contains a servo hold period corresponding to the defect as illustrated in FIG. 4A, resulting in generation of a servo error signal containing a defect detection signal, as shown in FIG. 4B. If the defect detection signal is input, the mono-multi-vibrator 310 outputs a pulse width modulation signal from the point when a servo hold pulse changes from a servo “on” state to a servo “hold” state (the defect detection signal processing shown in FIG. 4C(a)). A pulse width of the pulse width modulation signal is determined based on a register value. The pulse width of the pulse width modulation signal may be a limited pulse width within which the optical disc reproduction apparatus can stably perform tracking at the exact time when the servo hold state changes to the servo “on” state. The limited pulse width can be adjusted by re-setting the register value. The limited pulse width can be obtained using a one-period eccentric component contained in the TE signal.

The AND gate 330 performs an AND logic operation on the pulse width modulation signal input from the mono-multi-vibrator 310 through a first input terminal of the AND gate 330 and the defect detection signal input through a second input terminal, and outputs a result of the AND logic operation to the servo signal processing unit 400 (the defect detection signal processing shown in FIG. 4C(b)). The AND gate 330 outputs, to the servo signal processing unit 400, a signal having a shorter pulse width out of the pulse width of the pulse width modulation signal input from the mono-multi-vibrator 310 and a pulse width of the servo error signal.

The servo signal processing unit 400 receives the result of the AND logic operation and outputs FOD and TRD signals of which a servo hold pulse width is adjusted. Servo control may be unstable due to a large size or an irregular shape of the defect, resulting in a failure to read data. For a high-density optical disc, since the distance between track pitches is very narrow, the possibility of a failure to read data is higher.

If a data read failure occurs, a pulse width of the servo hold signal output from the defect processing unit 300, as shown in FIG. 4D, changes when entering into the defect duration again to attempt reproduction of data, as illustrated in FIG. 5. The defect duration is the duration in which the optical disc reproducing apparatus detects the defect on the optical disc 10. A time delay added to the servo hold signal may be added within the limited pulse width so that the optical disc reproduction apparatus can secure track following performance while in the servo hold state. The additional time delay allows multiple attempts to read data from the optical information storage medium by means of a change of a reproduction position by maintaining the servo hold state during the delayed time even after the duration of the defect has ended.

In addition, in response to the time delay added to the servo hold signal, track and focus offsets are reflected on a track servo and a focus servo held at a servo holding time. By reflecting the track and focus offsets on a servo value immediately before the servo hold state begins, a reproduction position changes when the servo hold state is over, allowing an attempt to read the data.

The adjustment of the time delay and the track and focus offsets allows multiple data read attempts while operating in the servo hold state besides holding a track servo and a focus servo when a defect is detected according to the conventional defect processing method. Furthermore, after adjusting the time delay and the track and focus offsets, the data reading can be retried, and the retry process can be repeated multiple times. In the retry process, the time delay and the track and focus offsets can be set to various values. By adding the time delay and the track and focus offsets to the servo hold signal and retrying the data reading, a defect countermeasure can be improved.

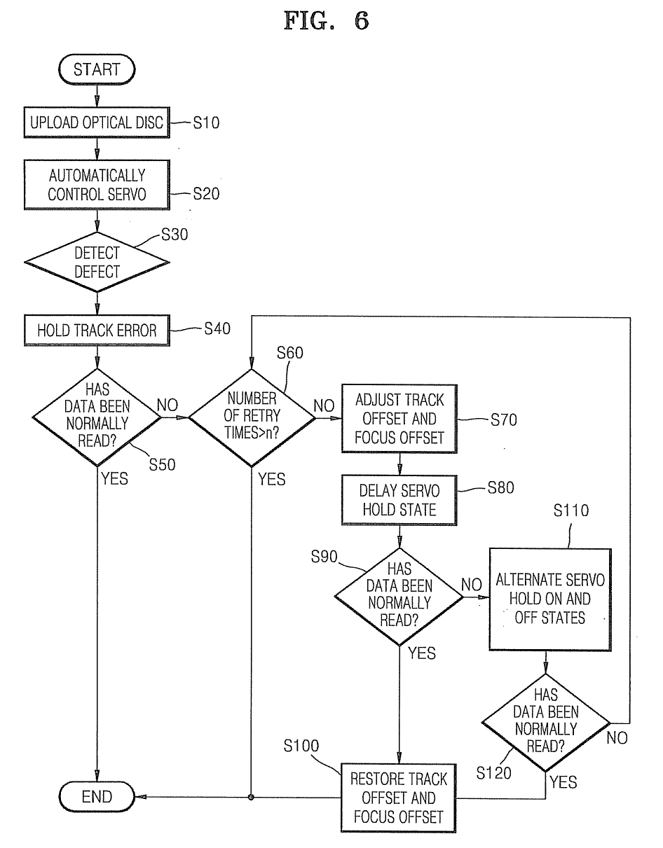

FIG. 6 is a flowchart of a method of processing a defect detection signal by adjusting an offset of a pulse width of a servo hold signal in the defect processing unit 300 according to an example embodiment of the present invention. When the optical disc 10 is loaded into the optical disc reproduction apparatus at block S10, a servo is automatically controlled by generating FE and TE signals to turn on a focus servo and a tracking servo at block S20. If a defect is detected at block S30 while data recorded on the uploaded optical disc 10 is being read, the servo, such as a TE servo, is held for the duration of the defect at block S40. Reading of the data on the optical disc 10 is attempted at block S50.

If the data is read normally, the method of processing a defect detection signal ends. If the data is not read normally, the data reading is retried. In the retry process, if a defect is detected, then at block S70 the servo signal processing unit 400 adds track and focus offsets to a servo value immediately before the defect is detected. A servo hold state is extended at block S80 by adding a time delay to a servo hold signal when the duration of the defect has ended while retrying the reproduction. The data reading is tried in a state where track and focus offsets are reflected during a servo hold on duration at block S90.

If the data is read normally at block S90, the track and focus offsets are restored to values in a normal state at block S100, and the process of processing a defect detection signal ends. If the data is not read normally, a servo hold on state and a servo hold off state are alternated at block S110, and the data reading is retried at block S120. If the data is read normally, the track and focus offsets are restored to the values in the normal state at block S100, and the method of processing a defect detection signal ends.

If the data reading fails in the retry process, the track and focus offsets are adjusted again, a time delay is added, and the process of entering into the defect duration with the readjusted track and focus offsets is performed again. However, the number of retry times is limited. If, at block S60, the number of retry times is greater than a predetermined number n, the method of processing a defect detection signal may end.

The term “unit”, indicates a hardware component, software, a Field Programmable Gate Array (FPGA), or an Application Specific Integrated Circuit (ASIC), and may’ perform predetermined functions. However, the term “unit” is not limited to software or hardware. A unit can be configured to be embodied in an addressable storage medium or to reproduce one or more processors. Thus, for example, the term “unit” encompasses components, such as software components, object oriented software components, class components, and task components, processors, functions, attributes, procedures, subroutines, program code segments, drivers, firmware, micro-code, circuits, data, database, data structures, tables, arrays, and variables. Functions provided by components, units, and modules can be combined to a smaller number of components and modules or further divided into additional components and modules. Furthermore, components and modules can be implemented to reproduce one or more Central Processing Units (CPUs) in a device.

The method of improving a defect countermeasure of an optical disc reproduction apparatus according to the present invention can be written as computer programs. Codes, and code segments for accomplishing the present invention can be easily construed by programmers skilled in the art to which the present invention pertains. Also, the computer programs are stored in a computer readable recording medium and read and executed by a computer system, thereby implementing the method of improving a defect countermeasure of an optical disc reproduction apparatus. Examples of the computer readable recording medium include magnetic recording media, optical recording media, and carrier waves (such as data transmission through the Internet).

As described above, according to aspects of the present invention, by reducing or delaying a servo holding time and adding track and focus offsets when defect processing fails in reading data, a defect countermeasure can be improved.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the optical information storage medium reproducing apparatus may be an optical information storage medium reproducing and/or recording apparatus that also records information onto the optical disk. The apparatus may also include a controller to control the optical pickup based on the servo drive signal and to control the optical pickup to reproduce the data stored on the optical disk. Accordingly, it is intended, therefore, that the present invention not be limited to the various example embodiments disclosed, but that the present invention includes all embodiments falling within the scope of the appended claims.

1-74. (canceled)

75. A cashless wagering game method, comprising:
storing on a personal data unit a personal identifier associated with a player of a gaming machine;
wirelessly communicating the personal identifier, between the personal data unit and the gaming machine;
authenticating the identity of the player based on the personal identifier at the gaming machine;
accessing a monetary account associated with the player, the monetary account associated with the personal identifier and stored on a host computer remotely coupled to the gaming machine;
receiving a wager from the player on the gaming machine; and
applying funds from the monetary account to operate the gaming machine in response to receiving the wager.

76. The method of claim 75, further comprising storing tracking information on the personal data unit and awarding a bonus outcome on the gaming machine based on the player tracking information.

77. The method of claim 75, further comprising storing tracking information including game play data on the personal data unit.

78. The method of claim 77, wherein the game play data includes the identity of a predetermined number of last machines played by the player and prizes awarded to the player.

79. The method of claim 75, further comprising randomly selecting an outcome from a plurality of outcomes in response to receiving the wager from the player.

80. The method of claim 75, wherein the monetary account is stored on the personal data unit.

81. The method of claim 75, wherein the accessing the monetary account is carried out by the gaming machine.

82. The method of claim 81, further comprising encrypting the personal identifier prior to the wirelessly communicating the personal identifier.

83. The method of claim 75, further comprising administering a plurality of player accounts, via the host computer.

84. The method of claim 83, wherein each of the player accounts include at least one of identity information relating to the player, monetary information, player tracking information, player preferences, casino preferences, or verification information.

85. The method of claim 84, wherein the verification information includes at least one of a verification code or a biometric attribute.

86. The method of claim 75, further comprising recording monetary transactions associated with the player of the gaming machine on the portable data unit and on the host computer.

87. The method of claim 75, further comprising storing a monetary balance associated with the monetary account on the host computer.

88. The method of claim 75, further comprising calculating an award to be awarded to the player at the host computer.

89. A cashless wagering game method, comprising:
wirelessly communicating a personal identifier between a portable internet device carried by a player and a gaming machine in a gaming establishment, prior to player interaction with the gaming machine;
authenticating the player identity based on the personal identifier;
linking the portable internet device to an outside financial institution on authentication of the player identity;
authorizing transfer of money from an account at a financial institution to a monetary account of the player, the monetary account associated with the personal identifier and the gaming establishment;
accessing the monetary account of the player; and
operating the gaming machine in response to receiving a wager from funds from the monetary account.

90. The method of claim 89, wherein the portable internet device is a cellular telephone.

91. The method of claim 90, wherein the monetary account is stored on the portable internet device.

92. The method of claim 90, wherein the monetary account is stored on a host computer in communication with the gaming machine.

93. The method of claim 90, wherein the monetary account is stored on the gaming machine.

94. A cashless gaming system, comprising:
a gaming machine at a gaming establishment;
a portable internet device carried by a player including a wireless transceiver to wirelessly communicate a personal identifier to the gaming machine prior to player interaction with the gaming machine, the portable internet device capable of communication to an outside financial institution, the portable internet device further capable of authorizing transfer of funds from an account at the financial institution to a monetary account of a player, wherein the monetary account is associated with the personal identifier and the gaming establishment;
an authentication module for authenticating the identity of the player based on the personal identifier; and
wherein based on the authenticating, the gaming machine accesses the monetary account of the player and allows the player to operate the gaming machine in response to receiving a wager from funds associated with the monetary account.
